(19) United States
(12) Patent Application Publication
(10) Pub. No.: US 2024/0320041 A1
(43) Pub. Date: Sep. 26, 2024

(54) Co-Operative Scheduler with Detection of Task Executing Longer than an Expected Execution Time Without Interrupting Execution of the Task

(71) Applicant: Microchip Technology Incorporated, Chandler, AZ (US)

(72) Inventor: Avinash Halageri, Karnataka (IN)

(73) Assignee: Microchip Technology Incorporated, Chandler, AZ (US)

(21) Appl. No.: 18/470,508

(22) Filed: Sep. 20, 2023

(30) Foreign Application Priority Data
Mar. 21, 2023 (IN) 202311019603

(51) Int. Cl. G06F 9/48

(52) U.S. Cl. CPC G06F 9/4887

(57) ABSTRACT

A device having a co-operative scheduler of a task of an application, a timer circuit to detect a task of the application executing longer than an expected execution time for the task without interrupting execution of the task; and a record circuit to record that a task has been detected by the timer circuit executing longer than the expected execution time. A method for co-operative scheduling of tasks of an application, detecting a task of an application executing longer than an expected execution time for the task without interrupting execution of the task, and recording that an overrun has been detected.

### CROSS-REFERENCE TO RELATED APPLICATIONS

This application claims priority to India patent application Ser. No. 202311019603, filed Mar. 21, 2023, which is hereby incorporated by reference in its entirety as if fully set forth herein.

### TECHNICAL FIELD

The present disclosure relates to co-operative schedulers and, more particularly, to detection and recording of an “incorrect allocation of execution time” task overrun in a co-operative scheduler.

### BACKGROUND

The “design recommendation,” defined in Annexure D, ISO 26262, Part 6:2018, available from the International Standards Organization, Geneva, Switzerland, aims at achieving “freedom from interference” between software elements. The software elements in the context of “co-operative schedulers” translate to tasks. One of the errors identified is task overrun called the “incorrect allocation of execution time.”

A Deadman Timer or Watchdog Timer (DMT/WDT) may provide a first line of defense for task overruns, i.e., task execution being stuck for some hardware module failure, infinite loops in the task, or other overruns without limitation. Task overruns due to software malfunctions despite validated allocation of execution time may be detected by DMT/WDT. Different from task overruns due to correctly allocated execution time, an “incorrect allocation of execution time” task overrun is an issue with the allocation of execution time by the user and could be due to insufficient loop timeout values for hardware access in the tasks, incorrect baud rate setting, or incorrect synchronization between tasks, all of which are correctable features.

A secondary timer may compute the execution time of the tasks because the primary timer is used by the co-operative scheduler to execute the tasks. A secondary timer may compute execution time of the tasks and subsequently detect task overruns, if any, by various means. To detect task overruns, the secondary timer may use an expected execution time for a particular task. This is taken as an input from the user through a parameter in the software application programming interface (API). This expected execution time is set as a period of the secondary timer. There are various methods to determine task overruns.

A first method may use the interrupt mechanism on the secondary timer. If the task execution time exceeds this period, an interrupt is generated indicating a task overrun. Unfortunately, the interrupt mechanism may temporarily “block the execution” of the task, which is a fault as per the Annexure D in ISO 26262-Part 6 standard. Secondly, to have uninterrupted access to the CPU, the tasks themselves may disable the interrupts during execution of critical sections of the code (for example, while reading a value from an analog to digital converter (ADC)). Also, the factor by which the task overshoots the expected execution time cannot be accurately computed, due to any intermediate jump to the Interrupt Service Routine (ISR).

A second method may configure a secondary hardware timer (if available) and configures its period to be equal to the “expected execution time” for the task. While a secondary timer is used in both this second method and the first method, a difference is that, in the first method an interrupt is generated once there is a timer overflow, and in this second method an interrupt is not generated but the timer overflow status is captured in the hardware register bit in the secondary timer module. Typically, interrupts are enabled so that upon a period match, an interrupt occurs and the corresponding interrupt service routine (ISR) is triggered to record the overflow. However, similar to the first method, this method blocks execution of the task. Because the interrupts partially block the execution of the code, this method is not feasible. Additionally, to alleviate the problem of interrupts partially blocking the execution of the code, the tasks themselves may disable the interrupts as part of execution of priority sections of the code. So if an overflow occurs during the execution of priority section of the code, the overflow event may be missed.

A third method may use the secondary timer in a non-interrupt mode, and check the timer overflow interrupt flag in the interrupt status register once the task execution is completed. A set flag indicates a task overflow. However, the interrupt status register may have both read and write access. If the application task clears the secondary timer overflow interrupt flag in the interrupt status register, then the overflow status may be lost.

A fourth method uses timer difference methodology to configure an additional hardware timer and configure its period to be equal to the “expected execution time” for the task. The timer is started and the timer value is recorded before and after the task execution. If the task execution continues after the rollover, the timer resets and starts counting from zero (0). However, the method does not differentiate between a simple difference between the two timer values and the difference after a rollover event. It may be difficult to differentiate between simple difference and difference after rollover, as both are positive values.

Software applications that use the mechanisms and features provided by co-operative schedulers need to execute the tasks in defined allocations of execution time. Software applications provide task definitions and co-operative schedulers provide the mechanisms to execute the tasks. The tasks have to give up the central processing unit (CPU) voluntarily to ensure that other tasks are not starved of the CPU resource. Because the scheduler does not block the execution of the task, task execution overruns should be identified and reported to the application by the co-operative scheduler. The currently available methods are intrusive and block the execution of the task temporarily to report the overrun, or do not provide unambiguous results.

There is a need for a co-operative scheduler that records an “incorrect allocation of execution time” task overrun without interrupting execution of the task.

### SUMMARY

According to an example, there is provided an apparatus, comprising: a co-operative scheduler of a task of an application; a timer circuit to detect a task of an application executing longer than an expected execution time for the task without interrupting execution of the task; and a record circuit to record that a task executing longer than an expected execution time has been detected by the timer circuit.

Another example provides a method, comprising: co-operative scheduling of tasks of an application; detecting a task of an application executing longer than an expected execution time for the task without interrupting execution of the task; and recording that a task executing longer than an expected execution time has been detected.

According to an example, there is provided a system, comprising: a co-operative scheduler of tasks of an application; a timer circuit; a record circuit; a memory to store instructions to operate the co-operative scheduler, the timer circuit, and the record circuit; and a processor coupled to the memory to execute the instructions to cause: the co-operative scheduler to schedule tasks of an application; the timer circuit to detect a task of an application executing longer than an expected execution time for the task without interrupting execution of the task; and the record circuit to record that a task executing longer than an expected execution time has been detected by the timer circuit.

### BRIEF DESCRIPTION OF THE FIGURES

The figures illustrate example co-operative schedulers that record an “incorrect allocation of execution time” task overrun when the task overruns its expected execution time, without interrupting execution of the task. Example co-operative schedulers may also notify the application defining the task of the “incorrect allocation of execution time” task overrun and provide to the application a correction factor for application to the expected execution time for tasks.

FIG. 1 shows a block diagram of a system for executing tasks of an application scheduled by a co-operative scheduler, a timer circuit and a record circuit for detecting and recording when a task executes for longer than an expected execution time.

FIG. 2 shows a more detailed block diagram of a system than shown in FIG. 1 having a co-operative scheduler, a timer circuit, a record circuit, a correction circuit, and an application programming interface.

FIG. 3 shows a flow chart of operation of the systems shown in FIGS. 1 and 2.

FIG. 4 shows a block diagram of an alternative timer circuit.

FIG. 5 shows a flow chart of operation of a system having the timer circuit of FIG. 4.

FIG. 6 shows a method for co-operatively scheduling tasks, detecting task overruns and recording the detected overruns.

FIG. 7 shows a block diagram of a device having a co-operative scheduler, a timer circuit and a record circuit.

FIG. 8 shows a block diagram of a system having a processor, a memory, a co-operative scheduler, a timer circuit, and a record circuit.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

An aspect provides a co-operative scheduler that records an incorrect allocation of execution time task overrun without interrupting execution of the task. The co-operative scheduler determines when a task has executed for longer than an expected execution time, records that the task has executed for longer than expected, and notifies the application defining the task of an “incorrect allocation of execution time” task overrun without interrupting execution of the task. According to one aspect, a co-operative scheduler provides to the application defining the task a correction factor for application to the expected execution time. The co-operative scheduler may have a correction circuit to correct the expected execution time by adding a correction factor based on the time the task executes after an incorrect allocation of execution time task overrun has been recorded. The co-operative scheduler may have a timer circuit to capture a run execution time of the task.

An aspect identifies the incorrect expected execution time allocation and provides a correction factor if the expected execution time allocated time is less than the actual time of execution. Rather than interrupting a task executing longer than expected, the actual time of execution may be captured and then a correction factor may be applied statically in the form of an “increased expected execution time.”

An aspect provides a method to detect incorrect allocation of execution time task overruns, record the detected overruns, and notify the user so the user can adjust the expected execution time of the task or modify the task implementation so that the execution time of the task will be within the expected execution time. A correction factor of a task overrun may be provided as information to the user. The correction factor may be applied by the user to revise the expected execution time and input the revised expected execution time using the same application programming interface (API) the user had initially used to input the expected execution time for the task. Alternatively, the user may revise the task for faster execution.

For example, a user initially inputs an expected execution time of 100 microseconds for a particular task using the API. However, the run execution time for a CPU to execute the task is 120 microseconds. The user is provided information that the task overran by 20 microseconds. The user may again use the same API to input a revised expected execution time of 120 microseconds for the task. A correction factor may be the actual execution time divided by the expected execution time. In this example, the correction factor may equal 120 microseconds divided by 100 microseconds, so that the correction factor equals 1.2 (CF=1.2). The correction factor may be multiplied by the original expected execution time to provide a revised expected execution time. Alternatively, the user may inspect the task to see where the extra 20 microseconds is being spent, and make suitable changes in the task so the CPU will be able to execute the task in less than 100 microseconds.

Aspects may be implemented as a feature in a co-operative scheduler to monitor the execution time of the tasks. Annexure D of Part 6 of the ISO 26262, 2018, standard describes “freedom from interference” for software elements (tasks) used in applications running on a CPU device that aspire for Functional Safety compliance. “Incorrect allocation of execution” is a fault in this annexure for the software elements (tasks). An aspect provides an update to the application defining a task running on a CPU device about task overruns for its allocated execution time. Detecting this task overrun may provide compliance with the ISO 26262 standard.

In one example, task overruns may be identified and recorded by using a combination of a timer circuit and a record circuit. From the software perspective, the “expected execution time” for every task is taken as a user input to the application defining the task running on a CPU device through an application programing interface (API). The timer circuit may be configured in a timer mode (e.g, interrupts disabled, or not enabled, as the feature may work without interrupts) with the “expected execution time” being input as a period of the timer. Before the execution of the task, a timer of the timer circuit is started, e.g., by setting a start bit in a start register of the timer circuit via task monitoring software code of the co-operative scheduler or a correction circuit. If there is a rollover, i.e., when the counter register matches the expected execution time in a period register, a detection output for the timer rollover may be available in a hardware register of the timer circuit. The timer rollover of the detection output may be a pulse output. However, a pulse output may not be captured independently as the signal is neither brought out onto any I/O pin and it may not be recorded in any special function register (SFR) of the timer circuit. The timer rollover may not be recorded independently, so a record circuit may capture the timer rollover event by inputting a detection output bit in a record register (a special function register (SFR)) of the record circuit.

Because user tasks scheduled by a co-operative scheduler for execution by a CPU have complete uninterrupted access to the CPU, the tasks should finish their execution within the “expected execution time.” However, if due to some issues the tasks violate the “expected execution time,” a method is provided to inform the user that a particular task has exceeded its “expected execution time.” The time allocated for a task (expected execution time) may be taken as an input from the user. Because the tasks have uninterrupted access to the CPU, they may not be interrupted either by other tasks, or by interrupts. In such a scenario, a method to record task overruns, without interrupting the execution of the tasks, may allow more efficient execution of the application. This may be important when used in relation to a functional safety compliant co-operative scheduler.

Embodiments provide circuits that may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Circuits may be implemented by instructions for execution by a processor through, for example, a function, application programming interface (API) call, script, program, compiled code, interpreted code, binary, executable, executable file, firmware, object file, container, assembly code, or object. For example, circuits may be implemented by instructions stored in a non-transitory medium such as a memory that, when loaded and executed by a processor (or any other suitable process), cause the functionality of the circuits described herein.

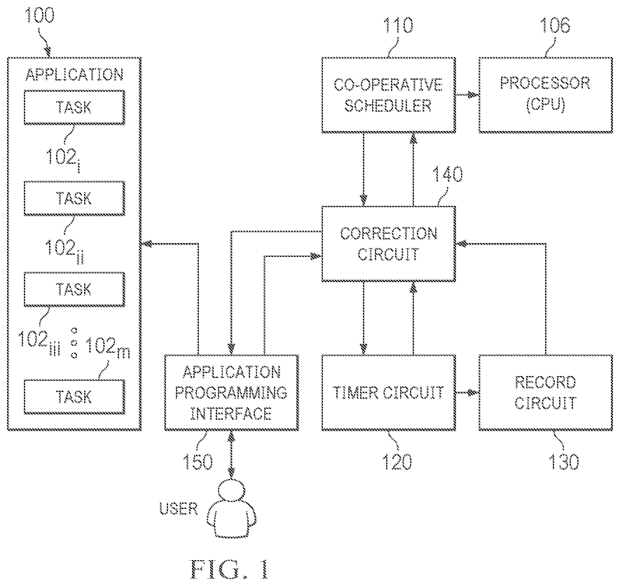

FIG. 1 shows a block diagram of a system for executing tasks of an application scheduled by a co-operative scheduler 110, a timer circuit 120 and a record circuit 130 for detecting and recording when a task executes for longer than an expected execution time. The system also has an application 100, a correction circuit 140, and application programming interface 150, and a processor (CPU) 106. The application 100 may have several tasks 102i through 102n. The timer circuit 120 may detect an overrun of a task 102i through 102n of application 100 executing longer than an expected execution time for the task without interrupting execution of the task. The record circuit 130 may record that an overrun has been detected by the timer circuit 120. The correction circuit 140 may allow a user to correct or revise the expected execution time via a correction factor after an overrun has been detected. The correction circuit 140 may be a combination of hardware and software, purely hardware, or purely software, without limitation. A correction factor may be a time remaining to complete execution of a task after a rollover event, an execution run time for a task, or a multiplier of the originally entered expected execution time. The correction circuit 140 provides a correction factor to the user of the application through the application programming interface circuit 150. The user may also use the application programming interface circuit 150 to provide the expected execution time, whether revised by a correction factor or not, to the timer circuit 120. The user may provide an update at least partially responsive to the correction factor. In one example, the correction circuit 140 may correct the expected execution time by adding the time the task executes after an overrun has been detected to the expected execution time.

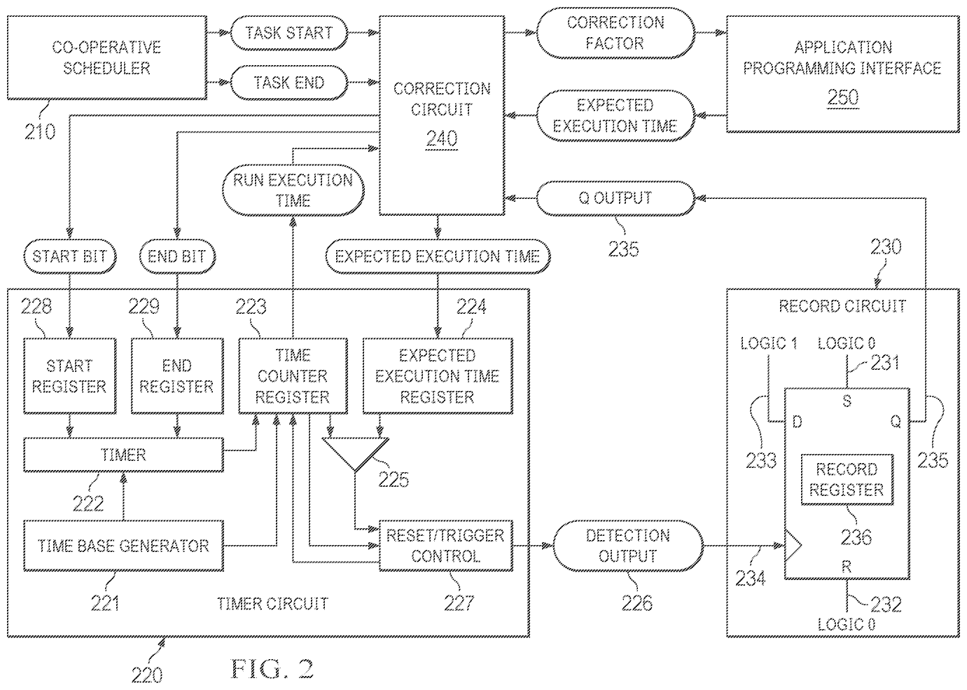

FIG. 2 shows a more detailed block diagram of several components shown in FIG. 1 for detection of a task overrun. A co-operative scheduler 210 provides a task start indication and a task end indication to a correction circuit 240. Upon receipt, respectively, the correction circuit 240 provides a corresponding start bit to the start register 228 in response to the task start indication and an end bit to the end register 229 of the timer circuit 220 in response to the task end indication. The correction circuit 240 also receives an expected execution time from a user via an application programming interface 250 and inputs the expected execution time into an expected execution time register 224 of the timer circuit 220. A timer circuit 220 has a time base generator 221, a timer 222, a timer counter register 223, an expected execution time register 224, start register 228, end register 229, and a comparator 225. The timer 222 acts as a controlled clock, responsive to the start register 228 and end register 229, and increments the timer counter register on a predetermined edge of a clock provided by time base generator 221. The time base generator 221 is part of a hardware module that provides the clock to count the timer 222, wherein the time base generator 221 may use clock signals available on the microcontroller including a system clock and other on-chip oscillator sources, as well as external clock inputs. A record circuit 230 may have a D flip flop, with Set and Reset inputs. The record circuit 230 may be formed of a configurable module, and have a configuration where the inputs can be controlled by software. The record circuit 230 may be hardware and provide S, R and D inputs 231, 232, 233, respectively, with software values 0, 0 and 1, respectively, as shown in FIG. 2.

A detection output 226 from the timer circuit 220 may be fed as the clock input 234 to the D flip flop of record circuit 230. A timer rollover may happen on various occasions. For example, when the timer counter register 223 reaches FFFF (hexadecimal), the timer counter register 223 may rollover to 0000 (hexadecimal). According to another example, if the expected execution time register 224 holds the expected execution time (e.g., 1234 (hexadecimal)), when the timer counter register 223 counts up from 0000 (hexadecimal) until it matches with the expected execution time register 224 (e.g., 1234 (hexadecimal)) then a comparator 225 signals a reset/trigger control 227 and the reset/trigger control 227 resets or rolls over the timer counter register 223 to 0000 (hexadecimal). The reset/trigger control 227 monitors the value in the timer counter register 223 and receives output signals of the comparator 225, and uses this information to note the value in the timer counter register 223 has rolled over to 0000 (hexadecimal) or to reset the value in the timer counter register 223. Whenever there is a rollover of the timer counter register 223 or a reset of the timer counter register 223, the reset/trigger control 227 may produce a pulse detection output 226, which is fed as a clock input 234 to the D flip flop of record circuit 230. This clock pulse latches the logic input that is fed at D input 233, which latched logic high which appears at Q output 235. This logical output can be directly read as a detection output bit from record register 236 available in the record circuit 230 once the task execution is completed. The rollover of the expected execution time register may be thus recorded in the record register 236 register while the task is executed without interruption. If there are two overflows, a watchdog reset may occur. Also, because the task execution is uninterrupted, the computation of its execution run time can be easily recorded, in both expected execution time register overflow and expected execution time register non-overflow scenarios. The correction factor in terms of excess time for the task may be provided to the user. The expected execution time can be corrected or in some cases suitable changes can be made in the implementation of the tasks to allow execution of the task to complete within the expected execution time. The detection output 226 may also be read from the record register 236 and be provided to the correction circuit 240. The correction circuit 240 may also read the run execution time from the timer counter register 223 of the timer circuit 220. The correction circuit 240 may calculate a correction factor and provide it to the user via the application programming interface 250.

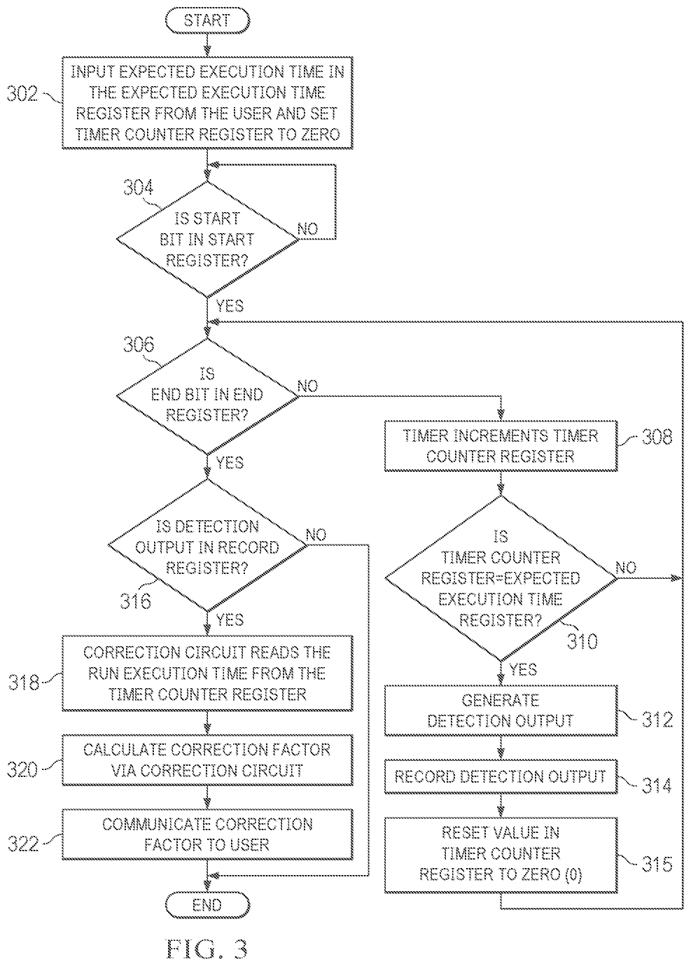

FIG. 3 shows a flow chart for detection of a task overrun via the timer circuit shown in FIG. 2. An expected execution time from the user is input 302 to the expected execution time register and the timer counter register is set to zero. The start register is checked 304 whether it has received a start bit indicating a task has started execution. If NO, return and again check 304 for the start bit. If YES, the end register is checked 306 whether it has received an end bit indicating the task has ended execution. If NO, the timer increments the timer counter register 308. The expected execution time in the expected execution time register is compared 310 with the value in the timer counter register to determine whether they are equal. If YES, a detection output is generated 312 by the reset/trigger control, the detection output is recorded 314, the value in the timer counter register is reset 315 to zero (0) by the reset/trigger control, and the process returns to again check 306 the end register. If NO, i.e., the expected execution time in the expected execution time register is not equal when compared 310 with the value in the timer counter register, the process returns to again check 306 the end register. If the end register is checked 306 and is determined, YES, the end register has received an end bit indicating the task has ended execution, then the process checks 316 whether a detection output is in the record register. If NO, the process ENDS. If YES, the correction circuit reads the run execution time from the timer counter register. The correction circuit then calculates 320 a correction factor in view of the expected execution time, the run execution time and the detection output in the record register indicating a rollover event. The correction circuit then communicates 322 the correction factor to the user via the application programming interface.

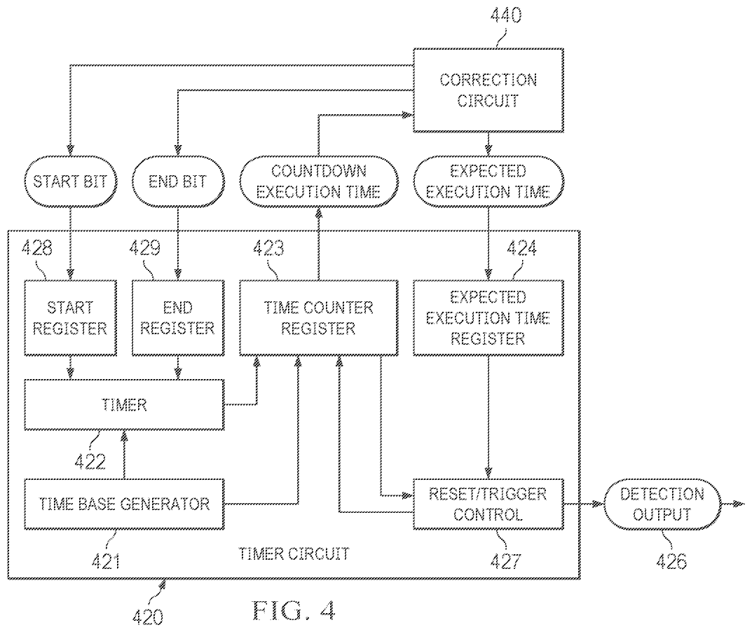

FIG. 4 shows an alternative timer circuit 420. This timer circuit 420 operates with a co-operative scheduler, an application programming interface, and a record circuit as shown in FIG. 2, but not shown in FIG. 4. Timer circuit 420 has a start register 428, an end register 429, a timer counter register 423, and an expected execution time register 424, similar to the timer circuit 220 shown in FIG. 2. Timer circuit 420 also has a time base generator 421, similar to the timer circuit 220 shown in FIG. 2. The time base generator 421 may provide a time base or clock for the rest of the timer circuit 420 using clock signals available on a microcontroller. This serves as the time base for the timer circuit 420 without depending on another on-chip timer circuit. Up to eight clock inputs may be available to the time base generator 421, including a system clock and other on-chip oscillator sources. Depending on the device, external clock inputs may also be available. A prescaler may divide the selected clock source to a suitable frequency for use by the timer circuit 420. The time base generator 421 may synchronize its operation with the selected clock source, subject to input timing restrictions or the circuit's operating conditions. Setting a timer synchronize bit may enable synchronization of the time base with the clock input.

However, the timer circuit 420 does not have a comparator and the timer 422 counts down to zero (0) rather than counting up from zero (0). A reset/trigger control 427 reads the expected execution time from the expected execution time register 424 and inputs that value into the timer counter register 423, which starts counting down from the expected execution time. The reset/trigger control 427 first inputs the expected execution time into the timer counter register 423 and the timer counter register 423 decrements the value in timer counter register 423 according to a clock signal from the time base generator 421 until it reaches zero (0). When the timer counter register 423 reaches zero (0), the reset/trigger control 427 receives that information from the timer counter register 423 and generates a detection output 426 indicating execution of the task has overrun the expected execution time. The detection output 426 may be sent to a record circuit as shown in FIG. 2, but not shown in FIG. 4. The reset/trigger control 427 rolls over the timer counter register 423 by again inputting the expected execution time from the expected execution time register 424 into the timer counter register 423, which again counts down toward zero (0). When the end bit is input from the correction circuit 440 into the end register 429, the timer circuit 420 stops decrementing, and the correction circuit 440 reads the countdown execution time from the timer counter register 423. If the record register 236 has recorded a rollover of the expected execution time register, the correction circuit 440 then calculates a correction factor as being equal to the expected execution time minus the countdown execution time. In this case, the correction factor is the amount of time the task executed beyond the expected execution time. The correction circuit 440 may communicate the correction factor to a user via an application programming interface (no shown). If the record register 236 has not recorded a rollover of the expected execution time register, then a correction factor need not be calculated. Alternately, if the record register 236 has not recorded a rollover of the expected execution time register, the countdown execution time from the timer counter register 423 may be reported as available time not utilized by the task.

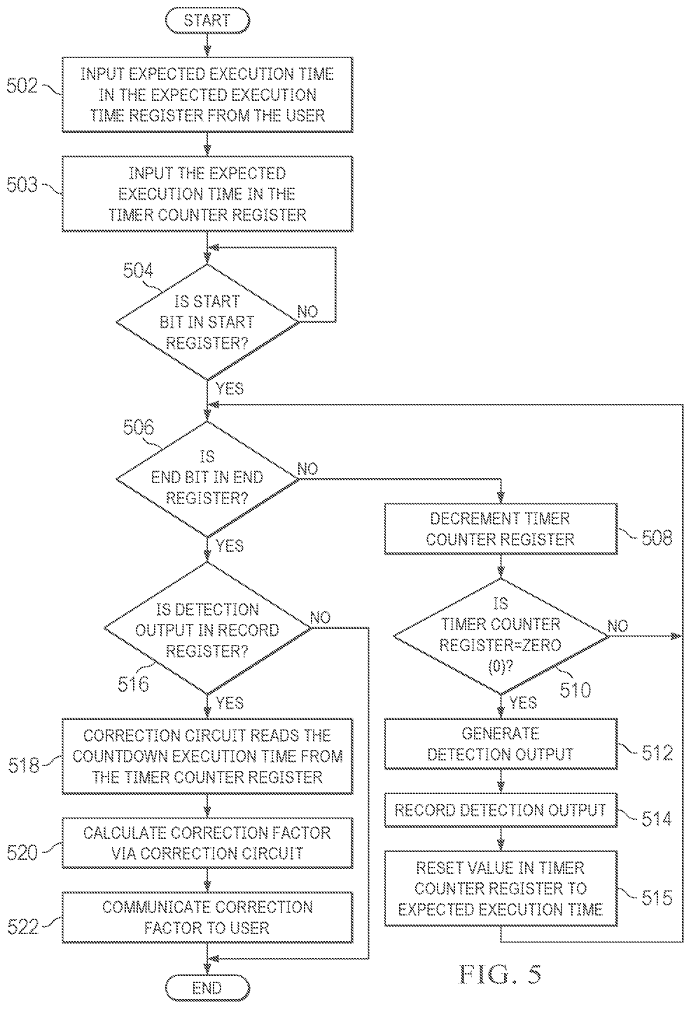

FIG. 5 shows a flow chart for detection of a task overrun via the timing circuit shown in FIG. 4. An expected execution time from the user is input 502 in the expected execution time register. The expected execution time from the user is also input 503 in the timer counter register. The start register is checked 504 whether it has received a start bit indicating a task has started execution. If NO, return and again check 504 for the start bit. If YES, the end register is checked 506 whether it has received an end bit indicating the task has ended execution. If NO, the timer counter register is decremented 508 according to a clock signal from the time base generator. The value in the timer counter register is checked 510 whether it is equal to zero (0). If YES, a detection output is generated 512, the detection output is recorded 514 by a record circuit, the value in the timer counter register is reset 515 to the expected execution time obtained from the expected execution time register, and the process returns to again check 506 the end register. If NO 510, the value in the timer counter register is not equal to zero (0), the process returns to again check 506 the end register. If the end register is checked 506 and is determined, YES, the end register has received an end bit indicating the task has ended execution, then the process checks 516 whether a detection output is in the record register. If NO, the process ENDS. If YES, the correction circuit reads the countdown execution time from the timer counter register. The correction circuit then calculates 520 a correction factor in view of the expected execution time, the countdown execution time and the detection output in the record register. The correction circuit then communicates 522 the correction factor to the user via the application programming interface.

An alternative timer circuit may increment the timer counter register according to the time base generator before, during, and after a task is executing. The timer circuit may also roll over the value of the timer counter register to zero (0) when it reaches the estimated execution time and generates a detection output. The correction circuit may read the value of the timer counter register when the start bit is input in the start register. The correction circuit may again read the value of the timer counter register when an end bit is input in the end register. The correction circuit may check for a detection output indicating a rollover occurred during task execution. If a rollover is indicated by a detection output, the correction circuit may determine total execution time of the task equals expected execution time plus the difference between the timer counter register values at start and end. If no rollover is indicated, then the correction circuit may determine the execution time of the task as equal to the difference between the timer counter register values at start and end. Safety mechanisms in the co-operative scheduler may provide a watchdog reset if the task takes at least twice the expected execution time.

Identification of task overruns (rollover events) may be recorded in the background while the CPU 106 is busy executing tasks 102i through 102n. See FIG. 1. Identification of task overruns (rollover events) may be recorded in software or hardware, indicating the task has overrun or not. Overruns may be recorded in hardware, with a detection output being set in a hardware register, wherein the detection output may be a binary bit (high or low) recorded in a register. The timer circuit 120 may identify task overruns (rollover events). The expected execution time may be loaded in an expected execution time register 224 (see FIG. 2), either before or during execution of the task by the CPU 106. See FIG. 1. Alternatively, a timer may be loaded with an expected execution time and the timer may countdown to zero (0) whereupon it may generate a rollover pulse indicating a task has executed for longer than the expected execution time.

Examples may record task overflows in hardware, without software intervention to record the overflow. Hardware examples may measure the lapsed execution time by incrementing or decrementing the timer counter register, record the overflow (detection output), and subsequently store the detection output as a bit in a hardware record register. See FIG. 2. The detection output 226 may be stored in hardware record register without CPU intervention and during the execution of the task. Examples may also have no external hardware connections (usage of external pins) to store the detection output in the hardware register. The signals may be routed internally and the status of the overflow may be captured or recorded as data in a memory (not shown). As shown in FIG. 2, the detection output 226 of the timer circuit 220 is sent to the record circuit 230 and the Q output 235 of the record circuit 230 is available in the record register 236.

Examples may also include software routines that are a part of a functional safety compliant co-operative scheduler, used in applications that run using these co-operative schedulers. The algorithms may avoid blocking of execution, deadlocks, livelocks, or incorrect allocation of execution time.

Task execution monitoring may be done for individual tasks. After completion of execution of an individual task, it is determined whether the individual task has overrun its expected execution time. Overrun determinations may be made respectively for individual tasks as they complete execution.

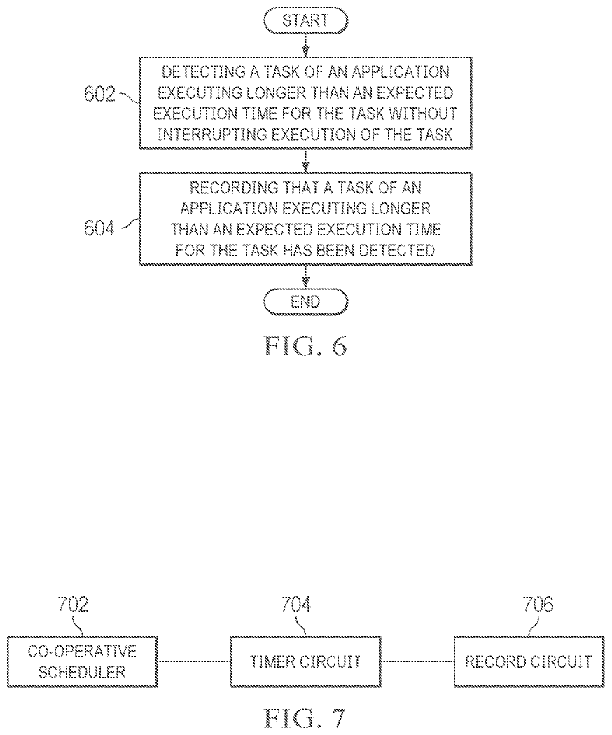

FIG. 6 shows a flow chart for a method. A task of an application is detected 602 executing longer than an expected execution time for the task without interrupting execution of the task. The task executing longer than an expected execution time that has been detected is recorded 604. Alternative examples of the method may report to a user task overruns (rollover events) beyond an expected execution time for the task, thereby allowing a user to correct the expected execution time, using a correction factor. The user may adjust the expected execution time for a particular task using the correction factor, so that the issue of incorrect allocation of execution time may be resolved.

Detection and correction of an expected execution time may include detecting extreme task overruns (e.g., stuck execution due to hardware failure, infinite loops in task) and mitigating the extreme task overruns by a watchdog timer or a dead man timer, which may still occur even after an expected execution time has been correctly allocated. A task overrun (rollover event) beyond an incorrectly allocated expected execution time for the task may be due to insufficient loop timeout, incorrect baud rate, or incorrect synchronization between software elements. These overrun causes may be correctable.

A co-operative scheduler may use a basic timer (primary timer) to execute tasks periodically. An additional or secondary timer may monitor the task execution time and task overruns. The secondary timer may be a timer circuit used in timer mode. The expected execution time for the task may be input by a user as the period of this secondary timer.

Referring to FIG. 2, the expected execution time is the value in expected execution time register 224 against which a run execution time in the timer counter register 223 is compared. When the run execution time in timer counter register 223 matches the expected execution time in expected execution time register 224, the time for the task is supposed to have lapsed, but the has not completed, since the end bit has not been stored in end register 229. For example, if the expected execution time of a particular task is 100 microseconds, this expected execution time may be set in the expected execution time register 224. When the timer 222 is started by a start bit being input in the start register 228, the value in the timer counter register 223 is zero (0), and the timer 222 periodically increments the timer counter register 223 responsive to timing signals received from time base generator 221. The comparator 225 compares the run execution time in the timer counter register 223 with the expected execution time in the expected execution time register 224. If they are equal, the comparator 225 will generate a detection output 226 and the value in the timer counter register 223 is reset to zero (0) by the reset/trigger control 227. Until the timer 222 is stopped by an end bit being input in the end register 229, the timer counter register 223 rolls over and continues counting from zero (0) until the next match with the expected execution time in the expected execution time register 224 or an end bit is input in the end register 229. Safety mechanisms in the co-operative scheduler may provide a watchdog reset if the task executes for longer than twice the expected execution time, wherein the watchdog timeout may be configured for twice the expected execution time of the task.

Alternatively, referring to FIG. 4, a timer may be loaded with a value corresponding to an expected execution time for a task and the timer may generate a rollover when the timer reaches “zero.”

Referring to FIG. 2, when a timer overflow is indicated due to a task overrun, a detection output 226 from the timer circuit 220 may be captured or recorded by the record circuit 230.

The pulse generated by the detection output 226 of the timer circuit 220 may be a pulse. To capture this pulse, the detection output 226 may be fed from the timer circuit 220 to the record circuit 230. The record circuit 230 may be configured as a D flip flop, with the detection output 226 fed to the clock input of the D flip flop, so that the pulse may generate a predetermined output of the D flip flop. In one example the predetermined output of the D flip flop in response to a pulse output from the detection output 226 is a logic HIGH output. In the absence of a pulse output from the detection output 226 the output of the D flip flop is the opposite of the predetermined output, which in this example is a logic LOW output. The output of the D flip flop of the record circuit 230, i.e., Q output 235, may be captured in a bit of the record register 236 (see FIG. 2), as shown in TABLE 1. Once the execution of the task is completed, the bit may be read to check for timer overflow, in turn indicating a task overrun (rollover event). An advantage of this method is that the timer overflow capture happens seamlessly while the task is executed without interruption.

TABLE 1

| Detection Output Bit | OUTPUT SIGNAL |
|---|---|
| 0 | No Rollover |
| 1 | Rollover |

Referring to FIG. 2, the time base generator 221 may provide a time base or clock for the rest of the timer circuit 220 using clock signals available on a microcontroller. This serves as the time base for the timer circuit 220 without depending on another on-chip timer circuit. Up to eight clock inputs may be available to the time base generator 221, including a system clock and other on-chip oscillator sources. Depending on the device, external clock inputs may also be available. A prescaler may divide the selected clock source to a suitable frequency for use by the timer circuit 220. The time base generator 221 may synchronize its operation with the selected clock source, subject to input timing restrictions or the circuit's operating conditions. Setting a timer synchronize bit may enable synchronization of the time base with the clock input.

The timer circuit 220 may generate a detection output 226 when the value in timer counter register 223 is equal to expected execution time register 224, and a rollover of the timer counter register 223 may occur. Detection output 226 may be made available to other circuits as a synchronization source or to trigger another peripheral to take action in response to a rollover event. The detection output 226 may be separate from the timer circuit's 220 device-level interrupts or other outputs. Timer circuit 220 may be a configuration of a capture compare pulse width modulation (CCP) circuit.

The record circuit 230 may be configured as a clocked D latch with Set (S) 231 and Reset (R) 232. A detection output 226 may be a low to high pulse and may be captured by record circuit 230 as a bit saved in the record register 236 and may be output from the record circuit 230 as a Q output 235 to the correction circuit 240. The correction circuit 240 may provide a correction factor to the user and may receive an expected execution time through the application programming interface circuit 250. The correction circuit 240 may provide the expected execution time, a correction factor, or a value representing a combination of the expected execution time and the correction factor to the expected execution time register 224 of the timer circuit 220 from the user.

Referring to FIG. 2, the correction circuit 240 may store an expected execution time in the expected execution time register 224. The timer circuit 220, may be implemented by a circuit configured in timer mode, without interrupts, with period=expected execution time, i.e., the time loaded in the expected execution time register 224. Whenever a task is executed, the timer 222 is started by inputting a start bit in a start register 228 and when the run execution time of the task (stored in the timer counter register 223) matches its expected execution time (stored in the expected execution time register 224), there is a timer rollover triggered by reset/trigger control 227, because the expected execution time (stored in the expected execution time register 224) is the same as the run execution time (in the timer counter register 223). The reset/trigger control 227 generates a detection output 226, which creates the detection output 226 pulse. As shown in Table 1, when the bit of the record register 236 is “0,” the Q output 235 is low so as to indicate no rollover. When the bit of the record register 236 is “1,” the Q output 235 indicates a rollover. The detection output 226 is fed to the record circuit 230 in D Flip Flop configuration so that pulse is captured or recorded in the record register 236, and the record circuit 230 outputs a Q output 235 to the correction circuit 240. Once the task completes its execution, the bit stored in the record register 236 indicates a task execution overrun, if any. The execution of the task is not interrupted, and overruns if any, are captured or recorded. After the rollover is captured or recorded, the run execution time may be read by the correction circuit 240 from the timer circuit 220. The correction circuit 240 may calculate a correction factor based on there being a Q output 235 and the value of the run execution time. The correction circuit 240 may report the correction factor to a user, through an application programming interface circuit 250, which indicates a task overrun has occurred. The user may correct the allocation of execution time, using a correction factor and input a revised expected execution time to the correction circuit 240 through the application programming interface circuit 250. The user may adjust the expected execution time for a particular task using the correction factor, so that the issue of “incorrect allocation of execution time” may be resolved. The correction factor may be reported to the user, so the user may decide whether to apply the correction factor. The correction factor may equal the total execution time minus the expected execution time, or the correction factor may be a time remaining to complete execution of a task after a rollover event, an execution run time for a task, or a multiple of the originally entered expected execution allocation. The user may use the correction factor to make changes in the task code to make sure the task execution falls within the expected execution time or use this correction factor to modify the expected execution time. Correction is not done dynamically during task execution run time. By making use of this correction factor, the issue with regard to “Incorrect Allocation of execution time” for a task can be resolved.

Aspects identify task overruns and provide a correction factor to the user so that the user may input adjustments so the tasks execute well within the expected execution time. The user of the application may resolve the issue of “incorrect allocation of execution time” when a correction factor is provided.

Based on the expected execution time, if the task completes its execution before the expected execution time, there is no timer rollover. The Q output 235 does not give any pulse, and the bit in the record register 236 is not SET. However, whenever the task exceeds the expected execution time, the execution is not interrupted, but the detection output 226 provides a pulse, which is captured by bit in the record register 236 of the record circuit 230 as Q output 235. Once the task execution is complete, the bit is checked for a detection output.

The timer circuit, record circuit, correction circuit, scheduler circuit, and API circuit may each be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. The circuits may each be implemented by instructions for execution by a processor through, for example, a function, application programming interface (API) call, script, program, compiled code, interpreted code, binary, executable, executable file, firmware, object file, container, assembly code, or object. For example, the circuits may each be implemented by instructions stored in a non-transitory medium such as a memory that, when loaded and executed by a processor (or any other suitable process), cause the functionality of the circuits, as described herein.

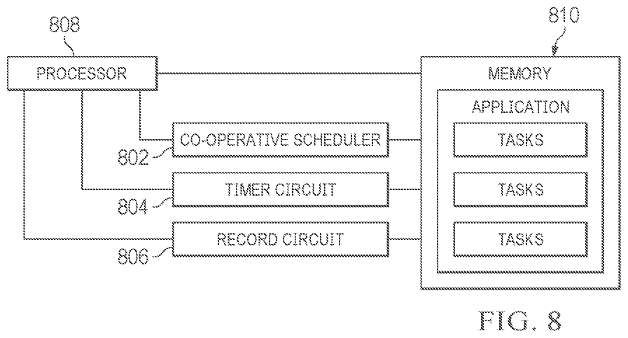

FIG. 7 shows a block diagram of a device, including: a co-operative scheduler 702; a timer circuit 704 to detect an overrun of a task of an application executing longer than an expected execution time for the task without interrupting execution of the task; and a record circuit 706 to record that an overrun has been detected by the timer circuit. FIG. 8 shows a block diagram of a system, including: a co-operative scheduler 802 of tasks of an application; a timer circuit 804; a record circuit 806; a memory 810 to store instructions to operate the co-operative scheduler 802, the timer circuit 804, and the record circuit 806; and a processor 808 coupled to the memory 810 to execute the instructions to cause: the co-operative scheduler 802 to schedule tasks of an application; the timer circuit 804 to detect an overrun of a task of an application executing longer than an expected execution time for the task without interrupting execution of the task; and the record circuit 806 to record that an overrun has been detected by the timer circuit 804.

Although example embodiments have been described above, other variations and embodiments may be made from this disclosure without departing from the spirit and scope of these embodiments.

1. An apparatus, comprising:
a co-operative scheduler of a task of an application;
a timer circuit to detect a task of the application executing longer than an expected execution time for the task without interrupting execution of the task; and
a record circuit to record that the task of the application has been detected by the timer circuit executing longer than the expected execution time for the task.

2. The apparatus as claimed in claim 1, comprising a correction circuit to correct the expected execution time by adding a correction factor based on the time the task executes after an overrun has been detected.

3. The apparatus as claimed in claim 1, wherein the timer circuit is to capture a run execution time of the task.

4. The apparatus as claimed in claim 1, wherein the timer circuit is to increment a timer counter as the task executes and compare the timer counter and the expected execution time for the task, and generate a detection output when the timer counter and the expected execution time are equal, the detection output recorded by the record circuit so as to record that the task of the application has been detected by the timer circuit executing longer than the expected execution time for the task.

5. The apparatus as claimed in claim 1, wherein the timer circuit is to decrement a timer counter from the expected execution time toward zero (0) as the task executes and generate a detection output when the timer counter equals zero (0), the detection output recorded by the record circuit so as to record that the task of the application has been detected by the timer circuit executing longer than the expected execution time for the task.

6. The apparatus as claimed in claim 1, wherein the timer circuit comprises: a time base generator; a timer; a timer counter register to store timer counter values as the task executes; an expected execution time register to store an expected execution time for the task; and wherein the timer circuit is to generate a detection output based on a timer counter value stored in the timer counter register, the detection output recorded by the record circuit so as to record that the task of the application has been detected by the timer circuit executing longer than the expected execution time for the task.

7. The apparatus as claimed in claim 1, comprising an application programming interface to provide the expected execution time to the timer circuit.

8. The apparatus as claimed in claim 2, comprising an application programming interface to allow a user to provide a corrected expected execution time to the timer circuit.

9. The apparatus as claimed in claim 1, wherein the record circuit is to capture a pulse signal from the timer circuit, wherein the pulse signal output corresponds to a detection of a task overrun.

10. The apparatus as claimed in claim 8, wherein the timer circuit is to capture a run execution time of the task, and comprising a correction circuit to calculate a correction factor based on the expected execution time and the run execution time.

11. A method, comprising:
detecting a task of an application executing longer than an expected execution time for the task without interrupting execution of the task; and
recording that the task of the application executing longer than the expected execution time for the task has been detected.

12. The method as claimed in claim 11, comprising capturing a run execution time of the task.

13. The method as claimed in claim 11, comprising incrementing a timer counter as the task executes, and wherein detecting the task executing longer than an expected execution time comprises comparing the timer counter and the expected execution time for the task.

14. The method as claimed in claim 11, comprising correcting the expected execution time by adding a correction factor based on the time the task executes after the overrun has been detected.

15. The method as claimed in claim 11, comprising incrementing a timer counter as the task executes, storing the timer counter, storing an expected execution time for the task; and comparing the timer counter and the expected execution time for the task so as to detect the task of the application executing longer than the expected execution time for the task.

16. The method as claimed in claim 11, comprising interfacing with a user via an application programming interface to obtain the expected execution time for a task.

17. The method as claimed in claim 11, comprising interfacing with a user via an application programming interface to provide to the user a correction factor for a task.

18. The method as claimed in claim 11, comprising calculating a correction factor based on an expected execution time and a run execution time.

19. A system, comprising:
a co-operative scheduler of tasks of an application;
a timer circuit;
a record circuit;
a memory to store instructions to operate the co-operative scheduler, the timer circuit, and the record circuit; and
a processor coupled to the memory to execute the instructions to cause:
the co-operative scheduler to schedule tasks of an application;
the timer circuit to detect a task of an application executing longer than an expected execution time for the task without interrupting execution of the task; and
the record circuit to record the task executing longer than the expected execution time as detected by the timer circuit.

20. The system as claimed in claim 19, wherein the memory to store instructions and the processor coupled to the memory to execute the instructions to cause the timer circuit to: receive an expected execution time from a user via an application programming interface, increment a timer counter as the task executes, store the timer counter, and compare the timer counter and the expected execution time for the task so as to detect the task of an application executing longer than the expected execution time for the task.

21. The system as claimed in claim 19, comprising a correction circuit, wherein the memory to store instructions and the processor coupled to the memory to execute the instructions to cause the correction circuit to correct the expected execution time by adding to the expected execution time the time the task executes after an overrun has been detected.
